(19) United States
(12) Patent Application Publication
(10) Pub. No.: US 2021/0294570 A1
(43) Pub. Date: Sep. 23, 2021

(54) INFORMATION PROCESSING DEVICE, INFORMATION PROCESSING METHOD, AND STORAGE MEDIUM

(71) Applicant: CASIO COMPUTER CO., LTD., Tokyo (JP)

(72) Inventors: Atsushi SHIBUTANI, Saitama (JP); Naohiko YASUDA, Tokyo (JP)

(73) Assignee: CASIO COMPUTER CO., LTD., Tokyo (JP)

(21) Appl. No.: 17/199,916

(22) Filed: Mar. 12, 2021

(30) Foreign Application Priority Data
Mar. 19, 2020 (JP) 2020-049706
Jan. 26, 2021 (JP) 2021-010020

(51) Int. Cl. G06F 3/16; G06F 3/01

(52) U.S. Cl. CPC G06F 3/167; G06F 2203/011; G06F 3/165; G06F 3/011

(57) ABSTRACT

An information processing device to be carried by a user includes: one or more processors; and one or more memories storing a program to be executed by the one or more processors, wherein the program causes the one or more processors to performing the following: detecting at least one of a position and an attitude angle of the information processing device with respect to the user's body; and when the one or more processors detect that the information processing device has been moved to at least one of a prescribed position and a prescribed attitude angle under a prescribed operation status of the information processing device or under a prescribed behavioral status of the user, causing audio information relating to the corresponding prescribed operation status of the information processing device or the corresponding prescribed behavioral status of the user to output from a predetermined device.

### BACKGROUND OF THE INVENTION

### Technical Field

The present invention relates to an information processing device and an information processing method.

### Background Art

A technique has been proposed for the purpose of making it possible to play back distributed information by a simple operation without complicating the hardware and software of the user terminal. (See, for example, Japanese Patent Application Laid-Open Publication No. 2002-335575.)

### SUMMARY OF THE INVENTION

Various features and advantages of the invention will be set forth in the descriptions that follow and in part will be apparent from the description, or may be learned by practice of the invention.

The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides an information processing device to be carried by a user, comprising: one or more processors; and one or more memories storing a program to be executed by the one or more processors, wherein the program causes the one or more processors to performing the following: detecting at least one of a position and an attitude angle of the information processing device with respect to the user's body; and when the one or more processors detect that the information processing device has been moved to at least one of a prescribed position and a prescribed attitude angle under a prescribed operation status of the information processing device or under a prescribed behavioral status of the user, causing audio information relating to the corresponding prescribed operation status of the information processing device or the corresponding prescribed behavioral status of the user to output from a predetermined device.

In another aspect, the present disclosure provides a method performed by an information processing device carried by a user, comprising: detecting at least one of a position and an attitude angle of the information processing device with respect to the user's body; and when the information processing device detects that the information processing device has been moved to at least one of a prescribed position and a prescribed attitude angle under a prescribed operation status of the information processing device or under a prescribed behavioral status of the user, causing audio information relating to the corresponding prescribed operation status of the information processing device or the corresponding prescribed behavioral status of the user to output from a predetermined device.

In still another aspect, the present disclosure provides a non-transitory computer readable storage medium, storing a program executable by one or processors in an information processing device carried by a user, the program causing the one or more processors to perform: detecting at least one of a position and an attitude angle of the information processing device with respect to the user's body; and when the one or more processors detect that the information processing device has been moved to at least one of a prescribed position and a prescribed attitude angle under a prescribed operation status of the information processing device or under a prescribed behavioral status of the user, causing audio information relating to the corresponding prescribed operation status of the information processing device or the corresponding prescribed behavioral status of the user to output from a predetermined device.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is a block diagram showing a functional structure of an electronic circuit of a wrist terminal according to an embodiment of the present invention.

FIG. 2 shows a correspondence relationship between various operating statuses and information to be played back under the corresponding status according to the embodiment.

FIG. 3 is a flowchart showing processes performed by the processor under the automatic playback mode setting in a first operation example of the embodiment.

FIG. 4 is a flowchart showing processes performed on the information providing side in a second operation example of the embodiment.

FIG. 5 is a flowchart showing processes performed by the processor under the automatic playback mode setting in the second operation example of the embodiment.

### DETAILED DESCRIPTION OF EMBODIMENTS

Hereinafter, embodiments of the present invention will be described with reference to drawings. In these embodiments, the present invention is applied to a wristwatch-type wrist terminal worn on the wrist of the user in cooperation with an external mobile information terminal (not shown) such as a smartphone.

<Construction>

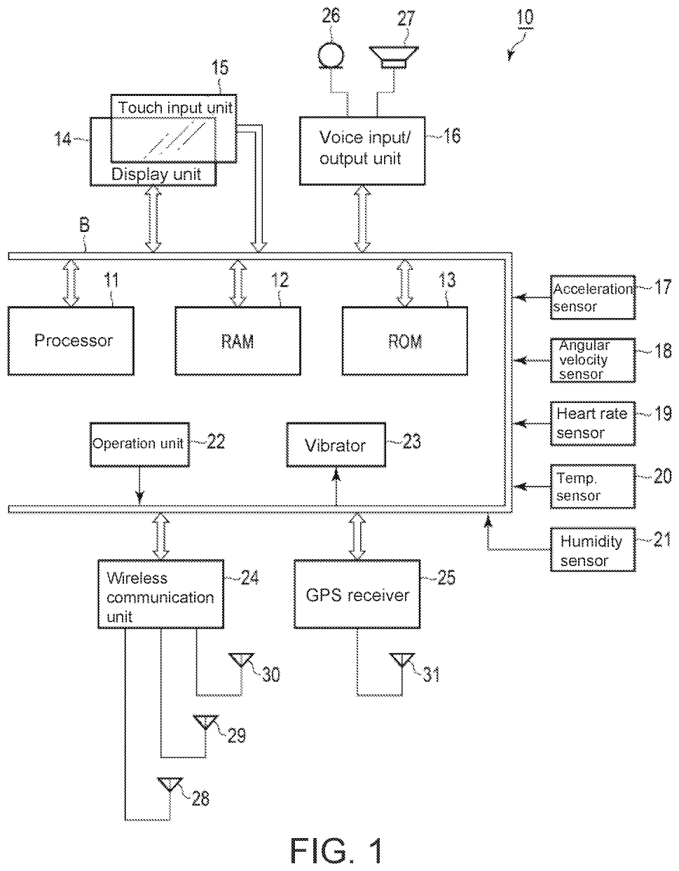

FIG. 1 is a block diagram showing a functional configuration of an electronic circuit of the wrist terminal 10 according to an embodiment of the present invention. As shown in the figure, the wrist terminal 10 includes at least one processor 11, RAM 12, and ROM 13.

The processor 11 reads out an operation program, various fixed data, parameters, etc., stored in a ROM 13 as at least one memory, such as a flash memory, expands and stores the operation program in a RAM 12 composed of an SRAM or the like, and then sequentially executes the operation program. As a result, the operations and the like described later are controlled in an integrated manner.

The ROM 13 also serves as a program memory for storing operation programs, various fixed data, parameters, and the like, and as a storage unit for storing various data handled by the application software at any time.

Display unit 14, touch input unit 15, voice input/output unit 16, acceleration sensor 17, angular velocity sensor 18, heart rate sensor 19, temperature sensor 20, humidity sensor 21, operation unit 22, vibrator 23, wireless communication unit 24, and GPS receiving unit 25 are connected to the processors 11, RAM 12, and ROM 13 via bus B.

The display unit 14 is composed of an organic EL, which is a self-luminous element, or a color TFT liquid crystal panel with a backlight and a drive circuit thereof, and displays display information given by the processor 11.

The touch input unit 15 is composed of a touch panel having a transparent electrode and a drive circuit therefor, which is integrally formed on the upper part of the display unit 14. The touch input unit 15 detects time-series coordinate positional information when a pressing operation is performed by a user's finger or the like, and sends out the detected time-series coordinate positional information to the processor 11.

The voice input/output unit 16 digitizes an electrical signal representing sound inputted via the microphone 26 to obtain voice information. The voice input/output unit 16 also reads out the voice information stored in the ROM 13 or generated by the processor 11 under control by the processor 11 and coverts it to an analogue signal, which is then amplified and outputted by the speaker 27.

The microphone 26 and the speaker 27 are arranged, for example, on the peripheral side faces of the housing of the wrist terminal 10. As is well known, the microphone 26 converts sound that includes surrounding voice into an electrical signal, and the speaker 27 converts an inputted electrical signal to sound and outputs it.

The acceleration sensor 17 is, for example, a mutually orthogonal three-axis acceleration sensor and detects the accelerations applied to the wrist terminal 10 worn by the user to output acceleration data. By processing the acceleration data output from the acceleration sensor 17 by the processor 11, for example, the processor 11 detects the position and attitude angle (including the gravitational acceleration direction) of the wrist of the user wearing the wrist terminal 10 with respect to the body.

The angular velocity sensor 18 is, for example, a mutually orthogonal three-axis angular velocity sensor, and detects the angular velocities applied to the wrist terminal 10 worn by the user to output angular velocity data. By processing the angular velocity data output from the angular velocity sensor 18 by the processor 11, for example, the processor 11 detects the rotation motion of the wrist of the user wearing the wrist terminal 10.

The heart rate sensor 19 is composed of an optical sensor arranged on the back surface of the housing of the wrist terminal 10 so as to come into contact with the outer skin of the wrist portion of the user wearing the wrist terminal 10, and measures the heart rate by measuring the changes in blood flow in the blood vessel of the wrist portion.

The temperature sensor 20 detects the temperature. The humidity sensor 21 detects the humidity. The data detected by each of the acceleration sensor 17, the angular velocity sensor 18, the heart rate sensor 19, the temperature sensor 20, and the humidity sensor 21 is sent to the processor 11 in appropriate timings. This way, the processor 11 obtains data from the various sensors 17-21.

The operation unit 22 receives the input of a key(s) directly operated by the user with the fingers, are provided on the outer surface of the housing of the wrist terminal 10, and sends the resulting key operation signal to the processor 11.

The vibrator 23 is composed of a motor having an eccentric weight attached to a rotating shaft and a driving unit therefor, and is driven at the time of an alarm or the like to generate vibration, to vibrate the entire wrist terminal 10.

The wireless communication unit 24 selectively performs, for example, information communication with mobile communication specifications in accordance with the LTE (registered trademark) (Long Term Evolution) standard via the antenna 28, information communication with wireless LAN specifications in accordance with IEEE802.11a/11b/11g/11n via the antenna 29, and information communication conforming to the short-range wireless communication technology of the BLE (registered trademark) (Bluetooth (registered trademark) Low Energy) standards via the antenna 30.

With short-range wireless communication based on the BLE (registered trademark) standard, the wrist terminal 10 may be paired with an external mobile information terminal such as a smartphone in advance so that the writs terminal 10 may operate in coordination with application software executed on the smartphone.

The GPS (Global Positioning System) receiver 25 receives incoming radio waves from a plurality of GPS satellites (not shown) via the GPS antenna 31, calculates three-dimensional coordinates (latitude, longitude, altitude) of the current position, and output the calculated results to the processor 11.

### First Operation Example

Next, the operation of the above embodiment will be described.

When operating the wrist terminal 10 in the present embodiment, various application software is being executed on an external mobile information terminal, such as a smartphone, owned by the user separately from the wrist terminal 10, and it is assumed that information communication is performed between the wrist terminal 10 and the smartphone with which the wrist terminal 10 is paired in response to various events, such as incoming calls, events generated by the application software, and the like.

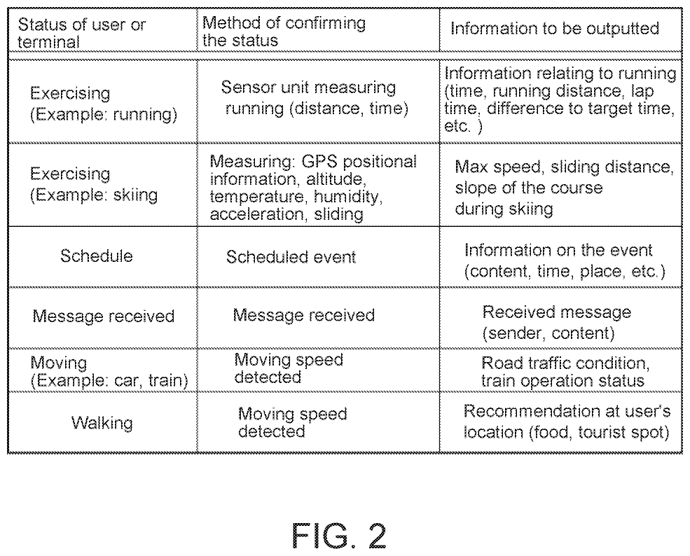

FIG. 2 shows an exemplary correspondence relationship between prescribed statuses and the corresponding voice information to be outputted in response, when the user of the wrist terminal 10 raises the wrist terminal 10 to the ear position, and the wrist terminal 10 determines that the wrist terminal 10 is placed at a prescribed position or at a prescribed attitude angle with respect to the user.

Here, the correspondence between “the status of the user or the terminal”, “the method of confirming (i.e., detecting/detecting) the status”, and “the information to be outputted” is illustrated in six exemplary cases.

In the first example, the status where the user with the wrist terminal 10 is “exercising” such as running will be described. As a method of confirming/detecting/detecting this status, for example, based on the output of a sensor unit such as an acceleration sensor 17 and a heart rate sensor 19, a vertical movement of the user's body, a movement speed higher than walking, and/or a state of a high heart rate due to running can be detected. In addition or alternatively, the function of the wrist terminal 10 or the application software launched on the wrist terminal 10 may be executing the measurements related to running, measuring time, running distance, lap time, a difference to the target time, etc. By detecting at least one of these metrics, the processor 11 or the like can confirm (i.e., detect/determine) the status of the exercising such as running. Further, although not shown, this can be confirmed by the time-dependent change of the current position detected by the GPS receiving unit 25 or the moving speed obtained by the time-dependent change of the current position. When it is confirmed that the user is “exercising” shown in this first example, information relating to running, such as the total time, running distance, lap time, and difference to target time, as measured, are outputted from the voice input/output unit 16 as voice information.

In the second example, the status of “exercising” being skiing, snowboarding, or the like will be described. This status may be confirmed by the processor 11 by detecting at least one of the following metrics, for example: the user is determined to be in a winter mountain such as a ski resort by measuring the current position and altitude information by the GPS receiver 25 and by referring to the map data stored in the ROM 13 of the wrist terminal 10; the vertical movement and the sliding motion of the user's body are detected by the output of the sensor unit such as the acceleration sensor 17 and the angular speed sensor 18; and the application software installed on the wrist terminal 10, for example, the ski sliding measurement software, is being launched and the sliding status and the like are being measured. Here, in detecting that the user is in a ski resort by referring to the map data and the current position and altitude acquired by the GPS receiver 25, data acquired by the temperature sensor 20 and the humidity sensor 21 may also be combined in the determination. When it is confirmed that the user is “exercising” shown in the second example, information on the user's maximum speed and the sliding distance, as the user slides, and the slope of the course at the user's current position, for example, is outputted from the voice input/output unit 16 as voice information.

Further, as a modification of this second example, the “exercising” may be playing golf. In this case, as a confirmation method, the processor 11 can determine the user is at the golf course by using at least one of the following ways: obtaining the current position and altitude information by the GPS receiver 25 and referring to the map data stored in the ROM 13 of the wrist terminal 10; and detecting the user's swing motion and the like detected by the output of the sensor unit such as the acceleration sensor 17 and the angular velocity sensor 18. When the processor 11 determines that the player is “exercising” (playing golf here) in the modified example of the second example, the voice input/output unit 16 outputs information on the course and hole of the golf course where the user is located, for example, as voice information.

The third example describes the “schedule” status. As a method of confirming this status, the processor 11 or the like looks up on the schedule management function of the wrist terminal 10 or a smartphone externally connected to the wrist terminal 10 to determine a scheduled event recorded in the calendar and compares it with the current time. If the scheduled time of the “scheduled event” or a preset advance notice time, such as “10 minutes before”, arrives, information on the scheduled event, such as the time, place, and scheduled contents is output from the voice input/output unit 16 as voice information.

The fourth example describes the status of “message received.” As a method of confirming this status, the processor 11 or the like detects that the wrist terminal 10 or the smartphone externally connected to the wrist terminal 10 has received an e-mail or a message through various SNS (Social Networking Services). In this fourth example, information on the sender of the message, the content of the message, and the like is output from the voice input/output unit 16 as voice information.

The fifth example describes a “moving” status by car, train, or the like. As a method of confirming this status, the processor 11 may use at least one of the following ways: receiving outputs of the sensor unit such as the acceleration sensor 17 and the angular velocity sensor 18; detecting the moving speed obtained from the time-dependent change of the current position detected by the GPS receiving unit 25; and obtaining information on the current position by the GPS receiving unit 25 and referring to the map data stored in the ROM 13 of the wrist terminal 10 to determine that the user in on the road or train track. As for the moving speed by car or train in the fifth example, when the moving speed exceeds a predetermined speed, it may be determined that the moving speed is by car or train, for example. In the fifth example, information on road traffic information or train operation status is output as voice information from the voice input/output unit 16.

The sixth example describes a “walking” status. As a method of confirming this status, the processor 11 may use at least one of the following ways: receiving the output of the sensor unit such as the acceleration sensor 17 and the angular velocity sensor 18; detecting the moving speed obtained from the time-dependent change of the current position determined by the GPS receiving unit 25; obtaining information on the current position determined by the GPS receiving unit 25 and referring to the map data stored in the ROM 13 of the wrist terminal 10 to determine that the user is moving on a road. As for the movement speed by walking in the sixth example, the movement within a predetermined range determined in advance may be determined to be the movement by walking. In the sixth example, the voice input/output unit 16 outputs recommended information such as food and sightseeing spots and information on resting places or the like at the user's current position as voice information.

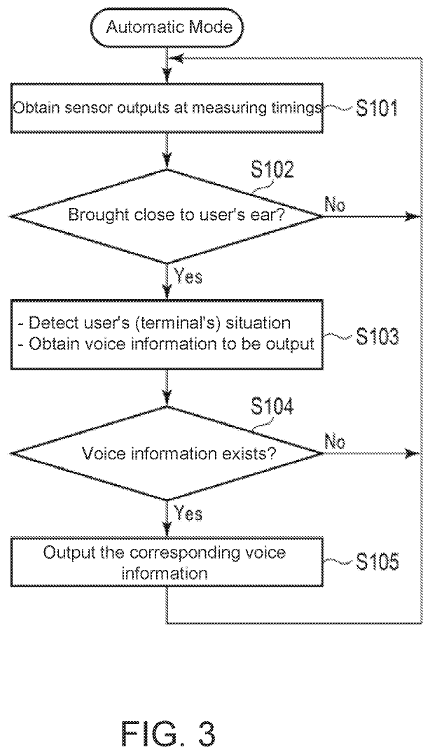

FIG. 3 is a flowchart showing processes performed mainly by the processor 11 when a mode for automatically output the voice information is set in the wrist terminal 10.

The processor 11 obtains the sensor outputs of the acceleration sensor 17, the angular velocity sensor 18, the heart rate sensor 19, the temperature sensor 20, and the humidity sensor 21 at preset measurement timings, for example, every 0.5 sec, and when it is configured to measure the current position by the unit 25 by the GPS receiving unit 25 (step S101), the processor 11 also obtains information on current position from the GPS receiving unit 25.

From the output of each of the acquired sensors, the processor 11 determines whether or not the wrist terminal 10 worn by the user is brought close to the vicinity of the user's ear, particularly based on the output data of the acceleration sensor 17 and the angular velocity sensor 18 (step S102).

When it is determined that the wrist terminal 10 is not close to the user's ear (NO in step S102), the processor 11 returns to the process of step S101 and acquires the output data of each sensor at the next measurement timing.

By repeatedly executing the processes of steps S101 and S102, while detecting the outputs of various sensors and the like, the processor 11 waits until the wrist terminal 10 is brought close to the user's ear.

When it is determined in step S102 that the wrist terminal 10 is brought close to the user's ear (YES in step S102), as shown in FIG. 2, the processor 11 detects the user's status (the wrist terminal 10's status) and obtains voice information to be automatically outputted based on the output data outputted from each sensor of the wrist terminal 10, the operating status of the application running on the wrist terminal 10, or information on a message received by the wrist terminal 10 or the like (step S103).

Next, it is determined whether or not there is voice information to be automatically outputted (step S104). When it is determined that there is no voice information to be automatically outputted (NO in step S104), the processor 11 returns to the process of step S101.

If it is determined in step S104 that there is voice information to be automatically outputted (YES in step S104), the processor 11 causes the acquired voice information to output from the voice input/output unit 16 and the speaker 27 (step S105), and returns to the process of step S101.

When performing automatic playback/output of this voice information, when there are other external devices, such as smartphones and earphones, that comply with the short-range wireless communication technology (BLE (registered trademark) standard, etc.) that has been paired in advance, the voice information may be transmitted to the external device via the wireless communication unit 24 so as to be outputted from the external device instead of being outputted from the speaker 27 of the wrist terminal 10 via the voice input/output unit 16. This way, it is possible to realize an audio output operation that matches the user's usage environment.

In the automatic playback of the above-mentioned voice information, when a plurality of pieces of voice information is obtained, the priority according to the operating environment is determined from the operating environment at that time, and these pieces of information are played back in the order of higher priorities. This way, the information that is more relevant to the user can be presented in the order of priority.

Further, when it is determined that the wrist terminal 10 is brought close to the user's ear, the processor 11 may not only start the automatic playback of the voice information, but also indicates that the user has the voice information to be automatically played back by vibration caused by the vibrator 23 so as to give the user advance notice.

By doing so, the user can recognize that there is no automatically played back voice information when there is no advance notice by vibration by the vibrator 23.

Further, with respect to the voice information automatically played back when the wrist terminal 10 is brought close to the user's ear after the advance notice operation by the vibration of the vibrator 23, if the voice information is not automatically outputted again for a certain period of time, such voice information may be automatically deleted from the ROM 13 in which it has been stored. In this case, by allowing the user to set that period of time, the storage capacity of the ROM 13 can be effectively utilized

### Second Operation Example

In a second operation example, a case where a plurality of wrist terminals 10 having the configuration shown in FIG. 1, for example, two terminals operate in cooperation with each other via a network including the Internet and a server device (both not shown), is explained.

In this case, it is assumed that the first wrist terminal 10 and the second wrist terminal 10 have been set in advance as to what kind of voice information is exchanged with each other and under what kind of environment.

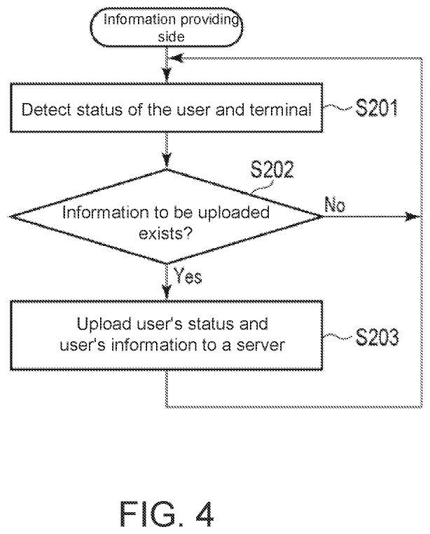

FIG. 4 is a flowchart showing processes performed by the information providing side when the first wrist terminal 10 and the second wrist terminal 10 are uploading voice information to be shared to each other to a server device (not shown).

Each processor 11 of the two wrist terminals 10 detects the status of the user and the wrist terminal 10 shown in FIG. 2 (step S201), and then determines whether or not there is voice information to be uploaded to the server device (step S202).

This determination is made, for example, by determining whether a predetermined status, such as where the user runs a predetermined lap distance (for example, in the interval of 1 km) after starting running during “exercise” using running application software described in the first example of FIG. 1, which triggers reporting of the lap time, has occurred.

If it is determined that there is no voice information to be uploaded to the server device (NO in step S202), the processor 11 returns to the process of step S201 and performs the processes of steps S201 and S202 again until the voice information to be uploaded can be obtained.

When it is determined in step S202 that there is voice information to be uploaded to the server device (YES in step S202), the processor 11 transmits information on the user's operating status (for example, distance information during running, lap time being measured, etc.) and the associated user information (user ID, terminal ID of the wrist terminal 10, etc.) to the server device (step S203), and returns to step S201 in preparation for the next upload.

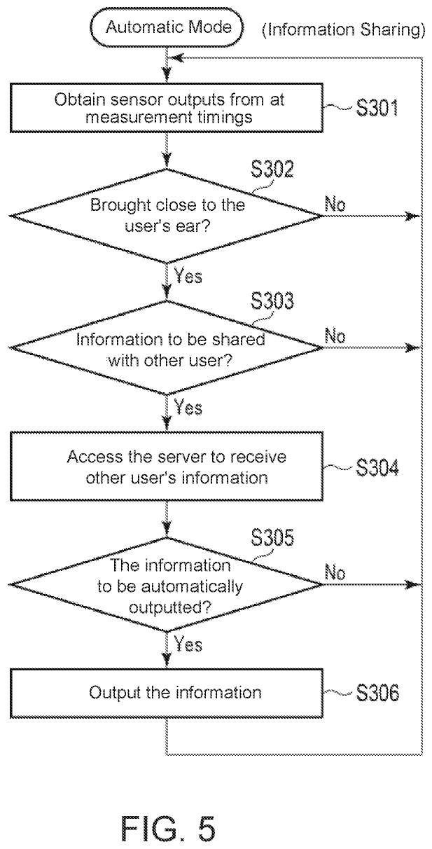

FIG. 5 is a flowchart showing processes of an automatic playback mode under the information sharing condition in which the first wrist terminal 10 and the second wrist terminal 10 download the voice information to be shared with each other from a server device (not shown).

The processor 11 of the wrist terminal 10 obtains the sensor outputs of the acceleration sensor 17, the angular velocity sensor 18, the heart rate sensor 19, the temperature sensor 20, and the humidity sensor 21 at preset measurement timings, for example, every 0.5 sec. If the GPS receiving unit 25 is to measure the current position according to the setting, the information of the current position determined from the GPS receiving unit 25 is also acquired (step S301).

The processor 11 determines whether or not the wrist terminal 10 is brought close to the user's ear based on the outputs of the acceleration sensor 17 and the angular velocity sensor 18 among the acquired output data of respective sensors (step S302).

When it is determined that the wrist terminal 10 is not close to the user's ear (NO in step S302), the processor 11 returns to the process of step S301 and obtains the output data of each sensor at the next measurement timing.

By repeatedly executing the processes of steps S301 and S302, the processor 11 waits until it determines that the terminal 10 is brought close to the user's ear while detecting the outputs of various sensors.

When it is determined that the wrist terminal 10 is brought close to the user's ear in step S302 (YES in step S302), the processor 11 determines whether or not the mode of information sharing with other users is set (step S303).

When it is determined that information sharing with other users has not been set (NO in step S303), it is assumed that the processor 11 does not need to download the voice information, and the processor 11 returns to step S301 in preparation for the next automatic playback process.

If it is determined in step S303 that information sharing with another user has been set (YES in step S303), the processor 11 accesses a predetermined server device via the network by the wireless communication unit 24, and if voice information has been uploaded to the server device, downloads the voice information via the receiving operation (step S304).

Subsequently, the processor 11 determines whether or not there is voice information to be automatically outputted (step S305). When it is determined that there is no voice information to be automatically outputted (NO in step S305), the processor 11 returns to the process of step S301.

When it is determined that the voice information obtained by the download is the voice information to be automatically outputted in step S305 (YES in step S305), the processor 11 causes the voice information obtained by the download to output from the speaker 27 via the voice input/output unit 16 (step S306), and then the process returns to the process of step S301 in preparation for the next automatic playback process.

Here, in step S302, the processor 11 may be configured to move to the automatic output process of voice information when it detects an additional prescribed action or actions, for example, an action in which the user twists the wrist on which the wrist terminal 10 is attached continuously a predetermined number of times, in addition to the detection of the wrist terminal 10 being brought close to the user's ear. By setting a combination of such additional actions, it is possible to prevent the automatic output of voice information from being accidentally started. Here, the processor 11 detects the twisting motion of the wrist on which the wrist terminal 10 is attached by using the output data from the angular velocity sensor 18. Further, the user's action and the number of such actions for preventing the automatic output of the voice information from being carelessly started are not limited to the wrist twisting action, and may be settable by the user among various actions that have been set in the wrist terminal 10. For example, a wrist snap or the like may be selected, and the user may set the number of such actions for triggering the automatic output.

Further, regarding the criterion for determining that the wrist terminal 10 is brought close to the user's ear, the wrist terminal 10 can be configured such that it is not uniformly determined from the output data of the acceleration sensor 17 and the angular velocity sensor 18, but individual differences of the user who owns the wrist terminal 10 and the like may be taken into account by making adjustments in advance in the wrist terminal 10. This way, it becomes possible to provide automatic output of the voice information at suitably individualized appropriate timings.

Further, regarding the voice information to be automatically outputted, the time stamp or the like associated with the voice information stored in the RAM 12 or the ROM 13 may be automatically updated, and for example, the voice information after a certain period of time has passed may be deleted. By doing so, it is possible to effectively utilize the RAM 12 or ROM 13 having a limited storage capacity and prevent a situation in which new voice information cannot be stored.

Further, when the voice information is automatically outputted, the content of the voice information may also be displayed on the display unit 14, and the user can see the automatically outputted voice information on the display unit 14, so that the user can surely confirm the content of the voice information. Here, the voice information output from the speaker 27 and the content of the voice information displayed on the display unit 14 are collectively referred to as audio information. Further, when the processor 11 obtains the voice information to be automatically outputted, the vibrator 23 may be vibrated or the speaker 27 may emit a predetermined alarm sound or beep sound before the voice information is actually outputted. This way, it is possible to notify the user that there is voice information to be automatically outputted. The vibrator 23 and/or the speaker 27 is an example of the notification unit that outputs notification information indicating to the user that the audio information has been obtained and is about to output from the information output unit.

Furthermore, the wrist terminal 10 may be configured such that the voice information that has been automatically played back/outputted once is not deleted immediately after the playback, but can be automatically played back again if within a predetermined time, so as to deal with situations where the user could not catch the content of the voice information or the user wishes to confirm the content again. Here, the predetermined time and the number of such automatic playbacks may be made user adjustable.

Here, the wrist terminal 10 may be configured such that the voice information to be automatically played back/outputted is not always played at a preset fixed volume, but the volume of playing may be raised in a noisy place or lowered in a quiet place based on the surrounding noise level collected by the microphone 26. By doing so, the voice information can be played at a volume suitable for the surrounding environment. The microphone 26 and/or the audio input/output unit is an example of the audio level acquisition unit that acquires an audio level outside of the information processing device, such as the wrist terminal 10.

### Effect of Embodiment

As described in detail above, according to this embodiment, it is possible to select and output information that is considered necessary or relevant to the user.

Here, the voice of the voice information output by the automatic playback may be made selectable by the user from a plurality of voice types prepared in advance, so that the user's preferred voice can be used in the output of the voice information.

Furthermore, the wrist terminal 10 may be configured such that one of a plurality of voice types is assigned and set according to the contents (for example, type, field) of the voice information to be outputted so that the user can easily recognize what category of the voice information the user is listing to.

Further, in the present embodiment, the wrist terminal 10 may be configured such that instead of or in addition to automatically playing back the voice information when it is determined that the wrist terminal 10 is brought close to the user's ear, the automatic output of the voice information is triggered when a user settable event occurs, such as when the user stands up from a sitting state, for example. This way, it is possible to customize the operations according to each user's individual preference or need.

Although the present embodiment has been described when applied to a wristwatch-type wrist terminal worn on the wrist of a user, the present invention is applicable to any wearable information terminal, such as smartphones and various other wearable devices as long as the information terminal is carried by the user.

In the above examples, the information that the user thinks is necessary can be selected and output, but instead or in addition to this, the information may be automatically transmitted to a predetermined external device. In this case, the information is transmitted to a predetermined external device via the wireless communication unit 24 of the wrist terminal 10. For example, in the case of exercise, which is the first example, information such as time and running distance measured during running may be transmitted to a predetermined external device. Further, for example, in the case of moving by car or train, which is the fifth example, information on road traffic and train operation status may be transmitted to a predetermined external device. Here, in these cases where the user is moving, such as running, moving by car or train, information on the route of the movement may be sent in addition to the above-described information. The information transmitted from the wrist terminal 10 this way may be transmitted to a predetermined single external device. Further, association information in which one or a plurality of external devices to which the information is transmitted are associated in advance depending on the type of the status of the user or the terminal may be stored in a memory part of the wrist terminal 10, and based on the type of the status of the user or the terminal and the type of the information to be transmitted, an appropriate one or more of the external devices may be selected as the transmission destination of the information. The information transmitted to the external device may be voice information, or text information that is converted from the voice information.

In addition, as another status example (the seventh example) of the above embodiment, the status of “working state” as the status of the user or the terminal will be described. This status can be confirmed by obtaining information on the start and end times at work, breaks (including their times) of work, meeting (including its time) from the schedule management function or work management function of the wrist terminal 10 or in a smartphone or the like externally connected to the wrist terminal 10. In the seventh example, the obtained information such as the start and end times of work, breaks (including their times), and meetings (including time) is output from the voice input/output unit 16 as voice information. Further, as described above, the voice information or the text-converted information of the voice information may be transmitted to a predetermined external device. Here, the wrist terminal 10 may be configured such that if the current position acquired by the GPS receiving unit 25 matches the position preset as a workplace and if the current time acquired from the processor 11 or the like is near the start time of work, then information indicating that the terminal 10 user has started work is transmitted to a predetermined external device. Needless to say, here, it is also possible to transmit information such as the end of work, the start of breaks, and the start of meetings as well as the start of work. Further, in addition to the information indicating that the work has started, the body temperature of the user at that time may be measured by a body temperature sensor (not shown) of the wrist terminal 10, and the measurement result may also be transmitted. The measurement timing of the body temperature may be set in advance by the user. In addition to the body temperature measured by the body temperature sensor, the measurement result measured by the heart rate sensor 19 may be transmitted.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention. For example, even if some constituent requirements are omitted from the constituent requirements shown in an embodiment, such a configuration can be regarded as an aspect of the present invention as long as it is within the scope of at least one of the appended claims.

What is claimed is:

1. An information processing device to be carried by a user, comprising:
one or more processors; and
one or more memories storing a program to be executed by the one or more processors,
wherein the program causes the one or more processors to performing the following:
detecting at least one of a position and an attitude angle of the information processing device with respect to the user's body; and
when the one or more processors detect that the information processing device has been moved to at least one of a prescribed position and a prescribed attitude angle under a prescribed operation status of the information processing device or under a prescribed behavioral status of the user, causing audio information relating to the corresponding prescribed operation status of the information processing device or the corresponding prescribed behavioral status of the user to output from a predetermined device.

2. The information processing device according to claim 1, wherein the predetermined device is an external device provided separately and externally from the information processing device.

3. The information processing device according to claim 1, wherein before causing the audio information to output from the predetermined device, the one or more processors cause notification information to output from the predetermined device, the notification information indicating that the audio information has been obtained and is about to output from the predetermined device.

4. The information processing device according to claim 1, wherein after the one or more processors has detected that the information processing device has been moved to said at least one of the prescribed position and the prescribed attitude angle, the one or more processors further determine whether the information processing device has been subsequently moved to at least one of another prescribed position and another prescribed attitude angle, and when the one or more processors determine that the information processing device has been subsequently moved to said at least one of said another prescribed position and said another prescribed attitude angle, the one or more processors cause the audio information to output from the predetermined device.

5. The information processing device according to claim 1, wherein the one or more processor adjust said at least one of the prescribed position and the prescribed attitude angle in response to an input from the user.

6. The information processing device according to claim 1, wherein the one or more processors cause date and time when the audio information that has been outputted from the predetermined device to be stored in a memory to keep track of the date and time of outputting the audio information from the predetermined device.

7. The information processing device according to claim 1, the one or more processors cause a content of the audio information outputted from the predetermined device to be displayed on a display.

8. The information processing device according to claim 1, wherein the one or more processors cause the audio information that has been outputted from the predetermined device to output from the predetermined device again if the user's request of such a second output occurs within a preset time after a first output.

9. The information processing device according to claim 1, wherein the predetermined device is a speaker, and the one or more processors obtain an audio level outside of the information processing device through a microphone, and adjusts an audio volume at which the audio information is outputted from the speaker based on the obtained audio level.

10. A method performed by an information processing device carried by a user, comprising:
detecting at least one of a position and an attitude angle of the information processing device with respect to the user's body; and
when the information processing device detects that the information processing device has been moved to at least one of a prescribed position and a prescribed attitude angle under a prescribed operation status of the information processing device or under a prescribed behavioral status of the user, causing audio information relating to the corresponding prescribed operation status of the information processing device or the corresponding prescribed behavioral status of the user to output from a predetermined device.

11. A non-transitory computer readable storage medium, storing a program executable by one or processors in an information processing device carried by a user, the program causing the one or more processors to perform:
detecting at least one of a position and an attitude angle of the information processing device with respect to the user's body; and
when the one or more processors detect that the information processing device has been moved to at least one of a prescribed position and a prescribed attitude angle under a prescribed operation status of the information processing device or under a prescribed behavioral status of the user, causing audio information relating to the corresponding prescribed operation status of the information processing device or the corresponding prescribed behavioral status of the user to output from a predetermined device.
